(19) United States
(12) Patent Application Publication
(10) Pub. No.: US 2008/0175995 A1
(43) Pub. Date: Jul. 24, 2008

(54) METHOD AND APPARATUS FOR PRINTING ADHESIVES AND PROVIDING TWO-PART INK SYSTEMS

(75) Inventors: Scott A. Boyd, White Bear Lake, MN (US); Jennifer L. Lee, Eagan, MN (US); Richard L. Severance, Stillwater, MN (US); Billy L. Weaver, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/017,721

(22) Filed: Jan. 22, 2008

Related U.S. Application Data
(60) Provisional application No. 60/886,338, filed on Jan. 24, 2007.
(60) Provisional application No. 60/886,417, filed on Jan. 24, 2007.

(51) Int. Cl. B05D 5/04; B05C 5/00

(52) U.S. Cl. 427/287; 427/288; 427/256; 118/300

(57) ABSTRACT

A system for printing adhesives immerses a wire in a reservoir of adhesive for a period of time sufficient to allow the wire to be coated with the adhesive. The system places the coated wire in close proximity to a designated medium onto which the adhesive will be applied and directs a stream of gas to contact the coated wire and cause at least some of the adhesive on the wire to be deposited onto the designated medium. Two-part ink systems include a fluid and a second material that is microencapsulated in the fluid, a second material that exists as a microemulsion in the fluid, and two fluids that are mixed or combined upon jetting and that react on the print medium.

### REFERENCE TO RELATED APPLICATION

The present application is related and claims priority to U.S. Provisional Patent Application Ser. Nos. 60/886417 and 60/886338, both of which were filed Jan. 24, 2007 and are incorporated herein by reference as if fully set forth.

### BACKGROUND

One known printer technology includes a print head that (1) immerses a wire in a reservoir of pigmented liquid material (e.g., ink) for a period of time sufficient to allow the wire to be coated with ink, (2) places the coated wire in close proximity to a print medium, and (3) directs a stream of air to contact the coated wire and thereby causes at least some of the ink on the wire to be deposited onto the print medium. The speed of the wire, the proximity of the wire to the print medium, and the force of the air stream may be digitally controlled by a processor, controller, microprocessor, or other computing device to ensure that a desired image resolution is achieved. By forming a print head with multiple wires; multiple, differently colored ink reservoirs; and multiple air streams, and by controlling and coordinating the metering of the ink and the position of the print head in relation to the print medium, a digital image can be created on a large-sized print medium. U.S. Pat. Nos. 5,944,893; 5,972,111; 6,089,160; 6,090,445; 6,190,454; 6,319,555; 6,398,869; and 6,786,971, all of which are incorporated herein by reference as if fully set forth, describe this printer technology in greater detail.

FIG. 1 is a perspective view of one embodiment of the above-identified prior art single color ink injector, generally indicated at 10, for depositing paint, ink, dye, or other liquid pigmented material that could be used for painting or printing onto a print medium to which a motor 14 is attached. A pulley 13 having a circumscribing groove 38 defined therein is secured to a shaft 15 of motor 14. An elongate frame member 32 depends from and is secured to a plate 12 and extends into a reservoir of ink 24. A rotatable or stationary guide 34 is attached to a distal end 37 of elongate frame member 32. Guide 34 is illustrated as a cylindrical, non-rotatable member having a groove 40 circumscribing guide 34 in which a wire cable 36, can slide during rotation of wheel 13. Wire cable 36 is described in greater detail in the above-identified patents. Wire cable 36 is disposed in groove 38 circumscribing the wheel 13 and in groove 40 circumscribing guide 34.

An elongate reservoir retaining member 16 is attached to plate 12 and includes a flange 18 defining a notch 20 between the flange 18 and elongate reservoir retaining member 16. Notch 20 is configured to receive a top lip 22 of ink reservoir 24. A bottom plate 26 is secured to a distal end 28 of elongate reservoir retaining member 16 with a threaded nut 31 that is threaded onto a threaded shaft 33. Threaded shaft 33 is secured to distal end 28 of elongate reservoir retaining member 16. Bottom plate 26 abuts against the bottom 30 of the ink reservoir 24 and holds it between flange 18 and bottom plate 26.

An air supply hose 42 is secured to a nozzle body 44 and supplies air through a nozzle orifice 46 that is aimed at a portion of cable 36. A cable guide 48 defining a longitudinal slot 50 is positioned proximate nozzle orifice 46. Cable 36 rides within slot 50 and is thus held in relative position to nozzle orifice 46 so that air passing therethrough does not substantially move cable 36 from in front of nozzle orifice 46 or cause cable 36 to substantially vibrate.

Rotation of shaft 15 is controlled by a controller, generally indicated at 57, comprising circuitry 54 in a module 56 that receives signals from a signal generating device 52, such as a personal computer employing a microprocessor or other devices that can supply discrete signals to instruct selective rotation of the shaft 15 of the motor. Circuitry 54 receives one or more signals from generating device 52 and rotates shaft 15 of the motor according to the signals.

In operation, ink contained in reservoir 24 is picked up by cable 36 and advanced by rotation of wheel 13, indicated by the arrow, in front of nozzle orifice 46. Air that is blown through nozzle orifice 46 disperses or pulls ink from cable 36 toward the print medium. Depending on the viscosity of the ink, the cross-sectional diameter of cable 36, and the diameter of wheel 13, a relatively precise amount of ink can be deposited on print medium. Such an apparatus may produce images having a resolution of approximately 50 dpi or better. The ink is dispersed onto a substrate 58, as illustrated in FIG. 2.

### SUMMARY

Embodiments consistent with the present invention are directed to an improved method of an apparatus for applying adhesives.

An improved adhesive applicator or fluid delivery system (1) immerses a wire in a reservoir of adhesive for a period of time sufficient to allow the wire to be coated with the adhesive, (2) places the coated wire in close proximity to a designated medium onto which the adhesive will be applied, and (3) directs a stream of gas to contact the coated wire and to thereby cause at least some of the adhesive on the wire to be deposited onto the designated medium. The speed of the wire and the force of the air stream may be digitally controlled by a processor, controller, microprocessor, or other computing device to ensure that a desired image resolution is achieved. Because the fluid delivery system is free of most of the mechanical limitations of traditional ink jet print heads, the system is compatible with adhesive application. When compared to the traditional coating operations for adhesives, the fluid delivery system allows controlled delivery, both in terms of location on the print medium and drop size (and thus coat weight). The system thus allows for greater positional and coat weight control of adhesives on the print medium or substrate, which is especially useful where precise control is desired.

One embodiment of the adhesive applicator includes a motor having a rotatable shaft, a wheel rotatable by the shaft of the motor, and an idler. A cable disposed around at least a portion of the wheel and a portion of the idler is advanceable by the wheel. The cable has a quantity of adhesive coated onto at least a portion of it. The cable is placed in close proximity to at least one fluid nozzle positioned and oriented for directing a jet of fluid toward the cable to remove an amount of the adhesive from the cable and direct the amount toward the medium onto which adhesive application is desired.

One method of applying adhesive to a desired medium involves coating at least a portion of an exterior surface of a cable with an adhesive and then placing the coated portion of the cable in close proximity to the designated medium. An air stream is then directed at the portion of the cable coated with the adhesive such that a metered amount of the adhesive is removed from the exterior surface of the cable and is deposited onto the designated medium.

The above-described print head is able to print a wide variety of materials because of its construction. Specifically, it lacks a nozzle through which the material to be printed must pass. Consequently, materials that could heretofore not be printed with a single print head in an ink jet printer can now be printed in this manner.

Embodiments consistent with the present invention are also directed to printing two-part ink systems using the printer described above.

One exemplary two-part ink system includes a fluid and a second material that is microencapsulated in the fluid material. Another exemplary two-part ink system includes a fluid and a second material that exists as a microemulsion in the fluid material. Another exemplary two-part ink system has two fluids that are mixed or combined upon jetting and that react on the print medium. Yet another exemplary two-part ink system includes a class of inks that are combined together before addition to the ink reservoir. Preferred two-part inks have a viscosity that is between about 200 cP and 2000 cP. These inks include, but are not limited to, urethanes, epoxies, reactive-crosslinked, and catalyzed systems.

One embodiment of a method involves coating at least a portion of an exterior surface of a cable with the two-part ink system and directing an air stream at the portion of the cable coated with the ink system. The force of air in the air stream causes a metered amount of the ink system to be removed from the exterior surface of the cable and to be deposited onto a print medium that is placed in close proximity to the cable. Advancement of the cable through the air stream is electronically controlled.

One embodiment of an apparatus for digitally printing a high resolution image on a print medium includes a support structure, a carriage associated with and movable in at least one direction relative to the support structure, and a plurality of paint injectors secured to the carriage. Each of the paint injectors includes a motor having a rotatable shaft, a wheel rotatable by the shaft, an idler, and an elongate segment disposed around at least a portion of the wheel and a portion of the idler. The elongate segment is advanceable by the wheel and has a quantity of fluid material coated onto at least a portion of it. The fluid material is a two-part ink system. The paint injectors also each include at least one fluid nozzle positioned and oriented for directing a jet of fluid toward at least a portion of the elongate segment to remove an amount of the fluid material from the elongate segment and direct the amount toward a surface of a print medium. A controller that is electronically connected to each motor controls the rotation of each wheel and controls the position of the carriage relative to the support structure.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of one embodiment of a fluid delivery system or printer;

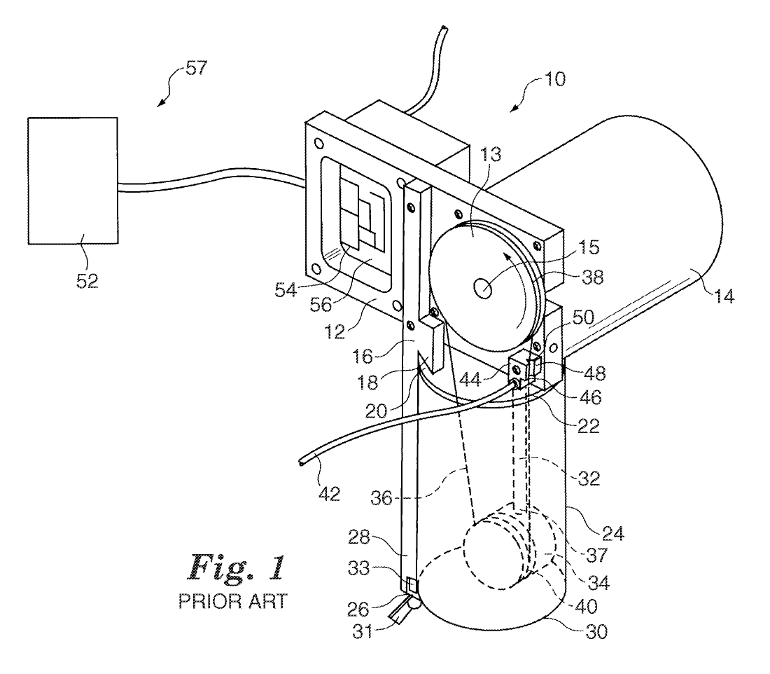

FIG. 2 is a side view of the fluid delivery system of FIG. 1; and

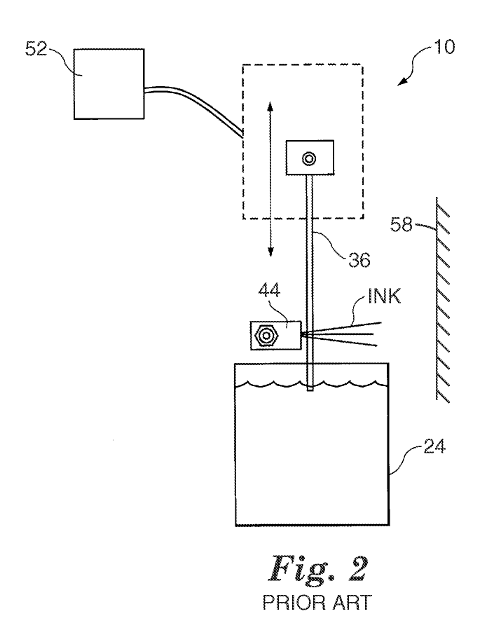

FIG. 3 is a diagram of a system to use the printer to print materials onto a substrate.

### DETAILED DESCRIPTION

### Printing Adhesives

In operation, adhesive contained in reservoir 24 is picked up by wire cable 36 and advanced by rotation of wheel 13, indicated by the arrow, in front of nozzle orifice 46. Air that is blown through nozzle orifice 46 disperses or pulls the adhesive from cable 36 toward the designated medium onto which adhesive application is desired. Depending on the viscosity of the adhesive in the reservoir, the cross-sectional diameter of cable 36, and the diameter of wheel 13, a relatively precise amount of adhesive can be dispensed. Further, because the adhesive to be dispensed does not pass through a nozzle, the percent solid of the adhesive can be greater than the prior art adhesive applicators permitted.

Exemplary adhesives that can be used in the adhesive applicator of the present invention include, but are not limited to, those in the following: U.S. Pat. Nos. 6,982,107; 6,946,177; 6,927,315; 6,911,243; 6,903,151; 6,887,917; 6,861,139; 6,855,386; 6,838,150; 6,835,271; 6,832,445; 6,777,080; 6,777,079; 6,767,935; 756,098; and 6,753,379. Preferred adhesives have a viscosity that is between about 200 cP and 2000 cP. These adhesives can be used in a wide variety of applications, including, but not limited to, consumer and office goods such as Post-it® Notes and related products; commercial graphics applications, such as billboards; traffic safety applications, such as signage and road markers; automotive applications; industrial applications, such as sandpaper; and medical applications, such as dental products.

The adhesive applicator of the present invention is based on printer technology that is described in U.S. Pat. Nos. 5,944,893; 5,972,111; 6,089,160; 6,090,445; 6,190,454; 6,319,555; 6,398,869; and 6,786,971, all of which are incorporated herein by reference as if fully set forth.

### Two-Part Ink Systems

The printer described above can be used to implement two-part ink systems.

One exemplary two-part ink system includes a fluid and a second material that is microencapsulated in the fluid material. The two materials can be designed to react with one another but would be prevented from doing so because of the physical barrier that the microencapsulation provides. When the two-part ink system is directed toward the print medium by force of the air stream, the momentum imparted is sufficient to burst the microbubbles and cause the fluids to mix or react. Alternatively, where the momentum is insufficient to burst the microbubbles, the force of the drop of ink colliding with the print medium will cause the microbubbles to burst and for the two materials in the two-part ink system to react or mix.

A second exemplary two-part ink system includes a fluid and a second material that exists as a microemulsion in the fluid material. The two materials could be designed to react with one another but would be prevented from doing so because of the physical barrier that the microemulsion provides.

A third exemplary two-part ink system includes two fluids that are mixed or combined upon jetting and that react on the print medium. This implementation could be effected, for example, by having two separate heads, each of which jets one of the two fluids such that they react or mix upon contact on the print medium. Alternatively, this implementation could be effected, for example, by mixing or combining the two fluids at the point of spraying.

A fourth exemplary two-part ink system includes two components or inks that are combined together before addition to the ink reservoir and thus before jetting. The two components are designed to be mixed together for optimal properties of the ink after application. These two-part ink systems have a viscosity that is between about 200 cP and 2000 cP and cannot be printed through existing ink jet systems.

As used herein, the term “ink” is meant to include any pigmented material, including, but not limited to, inks, dyes, paints, or other similarly pigmented liquids. While a wide variety of two-part ink systems could be used, one preferred class of two-part ink systems is epoxy-based systems.

As used herein, the term “print medium” is meant to include any print medium known in the art, including but not limited to paper, plastic, synthetic paper, metal foil, vinyl, and films, and variations thereof.

As used herein, the term “cable” is meant to include the use of a wire, a cable formed of multiple wires, a rod, a saw tooth wheel, or variations thereof.

### Multi-Color Printing

The printer described above can be used to generate digitally non-impact printed samples, potentially multi-colored, on the following materials: diaper fasteners; hooks; macro-closures; films; nonwovens; laminates; elastics; and superabsorbents. Also, it can be used to print on those materials using, for example, the following: adhesives; cohesives; coatings; lotions; skin care compositions; and absorbent compositions.

The non-impact digital printing can provide an improved overall cost, speed, quality, and flexibility. For elastics it provides cost effective stretch with elastomeric materials disposed only in specific areas and in specific amounts of printed ink with a large degree of flexibility in design patterns without investing in custom equipment such as rolls or dies for each new design or pattern needed for tailorability, aesthetics, and customization.

Customization, differentiation and performance enhancement via color, patterns, shapes, or combinations thereof is considered important for certain products. For example, a visual indication of a fit and status of a diaper is also an ever-growing need and trend. Current technologies do not allow for cost effective means of achieving these needs. For example, changing colors in an extrusion process can negatively impact yields, resulting in increased manufacturing costs. Providing multiple colored elastics with current technologies can be cost prohibitive. Also, ink printing of large areas becomes expensive. Moreover, to achieve intense colors, high amounts of ink have to be applied, which may lead to increased manufacturing costs and the ink rubbing off during use of the printed article. The printer described above, in addition to design flexibility, allows for easy integration of multiple colors in diaper components or other products. Colored and especially multi-colored elastics can provide for a visual indication of functional attributes such as a stretch indication.

The printer described above can also be used in a process for applying a composition onto a substrate web comprising the following steps: providing a substrate; and non-impact printing a composition onto at least one side of the substrate using a printer in which the composition does not pass through an orifice during the printing process. The resulting printed material can then be used as is, further processed, integrated with other materials or processes, or transferred onto other substrates.

### Printing System

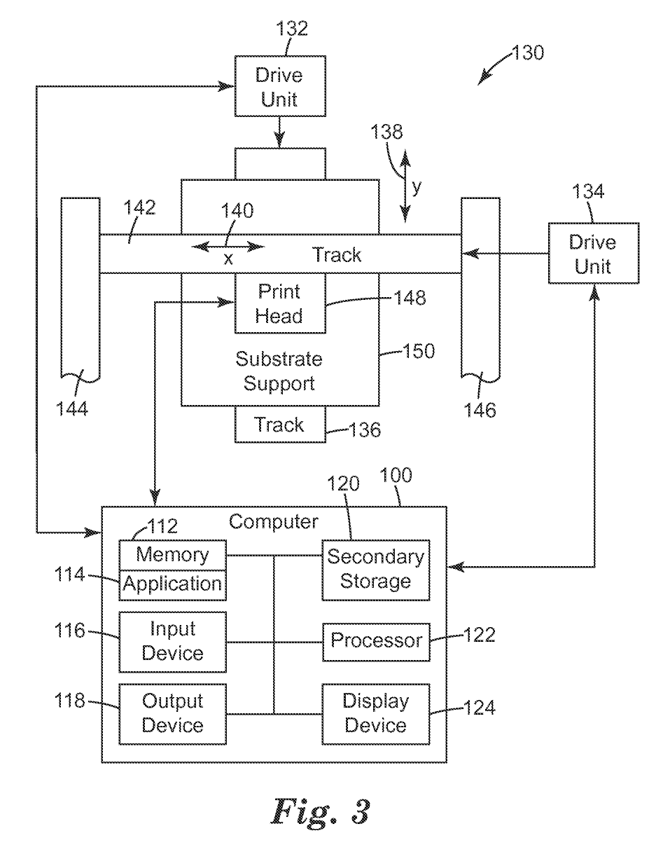

FIG. 3 is a diagram of a system 130 to use the printer to print ink onto a substrate. System 130 includes a print head 148 mounted on a track 142 supported by vertical posts 144 and 146, a wall, or other support. Print head 148 corresponds with printing system 10. A drive unit 134, using a motor, controls movement of print head 148 along track 142 in an x-direction as indicated by arrows 140. A substrate support 150 is located on a track 136, which would be supported by a vertical post, wall, or other support. A drive unit 132, using a motor, controls movement of substrate support 150 along track 136 in a y-direction as indicated by arrows 138. A substrate can be mounted or otherwise affixed to substrate support 150, and a line or pattern can be printed upon the substrate by print head 148. The configuration of the line or pattern is determined by the coordinated movement of print head 148 along track 142 and the substrate on substrate support 150 along track 136.

A computer 100, corresponding with controller 57 and used to implement controller 57, electronically controls print head 148 and drive units 132 and 134 for moving substrate support 150 and print head 148, respectively. Computer 100 can include, for example, the following components: a memory 112 storing one or more applications 114; a secondary storage 120 for providing non-volatile storage of information; an input device 116 for entering information or commands into computer 100; a processor 122 for executing applications stored in memory 112 or secondary storage 120, or as received from another source; an output device 118 for outputting information, such as information provided in hard copy or audio form; and a display device 124 for displaying information in visual or audiovisual form. Computer 100 can optionally include a connection to a network such as the Internet, an intranet, or other type of network.

Computer 100 can be programmed to control movement of print head 148 along track 142 and substrate support 150 along track 136. In particular, computer 100 can be programmed to electronically control movement of print head 148, via drive unit 134, in x-direction 140 laterally across a substrate on substrate support 150, and computer 100 can be programmed to electronically control movement of the substrate on substrate support 150, via drive unit 132, in y-direction 138 vertically with respect to print head 148. Computer 100 also controls print head 148, as described above, for movement of the wire and delivery of the ink from the wire to the substrate. Computer 100 can also be programmed to control an air solenoid in system 10. The use of tracks 136 and 142 for coordinated movement of substrate support 150 and print head 148, respectively, thus effectively functions as an X-Y stage for using the printer to print a wide variety of shapes and configurations of patterns, lines, or other elements. As an alternative, lines or patterns can be printed using one of the following techniques: coordinated movement of print head 148 in the y-direction and substrate support 150 in the x-direction; movement of print head 148 in both the x-direction and y-direction; or movement of substrate support 150 in both the x-direction and y-direction.

Computer 100 can also be programmed to control the printer for radial printing. In particular, a first orifice can direct an air jet at the wheel or wire to remove paint in a purely radial direction, while other orifices supplying air can be angled above the air jet created by the first orifice to help eliminate conical divergence of the paint as it is pulled from the surfaces of the wheel or wire.

1. A method of applying an adhesive to a print medium, comprising:
coating at least a portion of an exterior surface of a cable with an adhesive;
placing the coated portion of the cable in close proximity to the desired medium; and
directing an air stream at the at least a portion of the cable coated with the adhesive such that a metered amount of the adhesive is removed from the exterior surface of the cable and is deposited onto the print medium.

2. The method of claim 1, wherein the print medium comprises one of the following: paper; plastic; synthetic paper; metal foil; vinyl; or film.

3 The method of claim 1, wherein the cable comprises one of the following: a wire; a cable formed of multiple wires; a rod; or a saw tooth wheel.

4. A fluid delivery system, comprising:
a motor having a rotatable shaft;
a wheel rotatable by the shaft of the motor; an idler;
a cable disposed around at least a portion of the wheel and a portion of the idler and advanceable by the wheel, the cable having a quantity of adhesive coated onto at least a portion of it; and
at least one fluid nozzle positioned and oriented for directing a jet of fluid toward the at least a portion of the cable to remove an amount of the adhesive from the cable and direct the amount toward a print medium.

5 . The system of claim 4, wherein the print medium comprises one of the following: paper; plastic; synthetic paper; metal foil; vinyl; or film.

6. The system of claim 4, wherein the cable comprises one of the following: a wire; a cable formed of multiple wires; a rod; or a saw tooth wheel.

7. A method of printing with a two-part ink system, comprising:
coating at least a portion of an exterior surface of a cable with a two-part ink system;
directing an air stream at the at least a portion of the cable coated with the two-part ink system; and
electronically controlling advancement of the cable through the air stream such that a metered amount of the two-part ink system is removed from the exterior surface of the cable and is deposited onto the print medium.

8. The method of claim 7, wherein the two-part ink system comprises one of the following: a fluid and a second material that is microencapsulated in the fluid; a fluid and a second material that exists as a microemulsion in the fluid; two fluids that are mixed or combined upon jetting and that react on the print medium; or two components that are combined together before jetting.

9. The method of claim 7, wherein the print medium comprises one of the following: paper; plastic; synthetic paper; metal foil; vinyl; or film.

10. The method of claim 7, wherein the cable comprises one of the following: a wire; a cable formed of multiple wires; a rod; or a saw tooth wheel.

11. An apparatus for digitally printing a high resolution image on a print medium with a two-part ink system, comprising:
a support structure;
a carriage associated with and movable in at least one direction relative to the support structure;
a plurality of paint injectors secured to the carriage, each comprising:
a motor having a rotatable shaft;
a wheel rotatable by the shaft of the motor; and
an idler;
an elongate segment disposed around at least a portion of the wheel and a portion of the idler and advanceable by the wheel, the elongate segment having a quantity of a two-part ink system coated onto at least a portion of the elongate segment;
at least one fluid nozzle positioned and oriented for directing a jet of fluid toward the at least a portion of the elongate segment to remove an amount of ink from the elongate segment and direct the amount toward a surface of a print medium; and
a controller electronically connected to each motor for controlling rotation of each wheel and for controlling the position of the carriage relative to the support structure.

12. The apparatus of claim 11, wherein the two-part ink system comprises one of the following: a fluid and a second material that is microencapsulated in the fluid; a fluid and a second material that exists as a microemulsion in the fluid; two fluids that are mixed or combined upon jetting and that react on the print medium; or two components that are combined together before jetting.

13. The apparatus of claim 11, wherein the print medium comprises one of the following: paper; plastic; synthetic paper; metal foil; vinyl; or film.

14. The apparatus of claim 11, wherein the elongate segment comprises one of the following: a cable; a wire; a cable formed of multiple wires; a rod; or a saw tooth wheel.
